(19) United States
(12) Patent Application Publication
(10) Pub. No.: US 2013/0311322 A1
(43) Pub. Date: Nov. 21, 2013

(54) COMPUTER-IMPLEMENTED METHODS AND SYSTEMS FOR PROVIDING CUSTOMIZED PRODUCT OR SERVICE RECOMMENDATIONS TO TRAVELERS

(71) Applicant: Reservend, Inc., Cambridge, MA (US)

(72) Inventor: James Wayne Potter, Acton, MA (US)

(73) Assignee: RESERVEND, INC., Cambridge, MA (US)

(21) Appl. No.: 13/894,931

(22) Filed: May 15, 2013

Related U.S. Application Data
(60) Provisional application No. 61/648,117, filed on May 17, 2012.

(51) Int. Cl. G06Q 30/06

(52) U.S. Cl. CPC G06Q 30/0631
USPC 705/26.7

(57) ABSTRACT

Computer-implemented methods and systems are disclosed for providing customized product or service recommendations to a traveler in connection with a stay at a room provided by a lodging service.

### CROSS REFERENCE TO RELATED APPLICATION

This application claims priority from U.S. Provisional Patent Application No. 61/648,117 filed on May 17, 2012 entitled METHOD AND COMPUTER BASED SYSTEM FOR PROVIDING TARGETED AND RECOMMENDED ACTIVITIES, which is hereby incorporated by reference.

### BACKGROUND

The present application relates generally to targeted content delivery and, more specifically, to methods and systems for providing local product or service recommendations to travelers in connection with stays at rooms provided by lodging services.

### BRIEF SUMMARY

In accordance with one or more embodiments, a computer-implemented method is disclosed for providing customized product or service recommendations to a traveler in connection with a stay at a room provided by a lodging service. The method comprises the steps performed by a computer system of: (a) receiving data on products or services available from one or more vendors suitable for travelers staying at a room provided by the lodging service, data on the traveler, and data from personnel associated with the lodging service on preferred products or services; (b) based on the data received at (a), determining one or more recommended products or services for the traveler during the stay at the room provided by the lodging service; and (c) providing information on the one or more recommended products or services for delivery to the traveler.

In accordance with one or more further embodiments, a computer system is provided, comprising at least one processor, memory associated with the at least one processor, and a program supported in the memory for providing customized product or service recommendations to a traveler in connection with a stay at a room provided by a lodging service. The program has a plurality of instructions stored therein which, when executed by the at least one processor, cause the at least one processor to: (a) receive data on products or services available from one or more vendors suitable for travelers staying at a room provided by the lodging service, data on the traveler, and data from personnel associated with the lodging service on preferred products or services; (b) based on the data received at (a), determine one or more recommended products or services for the traveler during the stay at the room provided by the lodging service; and (c) provide information on the one or more recommended products or services for delivery to the traveler.

### BRIEF DESCRIPTION OF THE DRAWINGS

FIG. 1 is a simplified illustration of an exemplary network in which an activity recommendation system in accordance with one or more embodiments may be implemented.

FIG. 2 is a simplified block diagram illustrating an activity recommendation system in accordance with one or more embodiments.

FIG. 3 is a simplified diagram illustrating an exemplary process flow in accordance with one or more embodiments.

FIG. 4 is a simplified diagram illustrating the architecture of an exemplary activity recommendation system in accordance with one or more embodiments.

FIG. 5 is a screenshot illustrating an exemplary webpage showing recommended activities in accordance with one or more embodiments.

### DETAILED DESCRIPTION

The present application is directed to methods and systems for providing local product or service recommendations to travelers in connection with stays at rooms provided by lodging services. In the various exemplary embodiments described herein, the lodging service is indicated to be a hotel. It should be understood, however, that the methods and systems are equally applicable to a variety of other lodging services including, e.g., resorts, motels, inns, and bed-and-breakfast facilities. In addition, the methods and systems are applicable to nontraditional web-based lodging services such as, e.g., those provided by AirBnB.com and others.

Travelers typically do not have access to a concierge and the concierge's recommendations for local products or services (also referred to herein as activities) prior to their stay in a hotel. Briefly and as will be described in further detail below, in accordance with one or more embodiments, methods and systems are provided for enabling hotels to send messages (e.g., by e-mail, text message, social media message, or phone) to travelers with recommended activities to use during their stay and optionally discounts associated with those activities. The activities are preferably validated for accuracy and appropriateness by the system. The messages can be sent prior to and/or during their stay in the hotel without the hotel having to switch email service providers or property management systems. Travelers can reserve the activities and receive the discounts clicking on the links in the emails or other messages. Once the activities are booked, hotels can then customize additional offers to the travelers during their stay based on the knowledge of what the traveler is planning on doing and thereby create a better experience for the traveler.

The methods and systems allow hotels to have greater control over and influence on the traveler's experience. They also enable vendors, who supply the activities, advertising access to travelers they know will be coming to their local areas earlier than they normally would be able to with traditional systems. Also, because finding trusted activities during vacation or other travel is generally difficult, requiring travelers to sift through large amounts of internet clutter, the computer based methods and systems also ease this process for travelers by sending them customized messages on what activities the hotel recommends as a trusted activity based on the traveler's preferences. Customizing messages to the traveler may include using information about a traveler's stay (e.g., time and location), about the traveler's activity preferences, and the like.

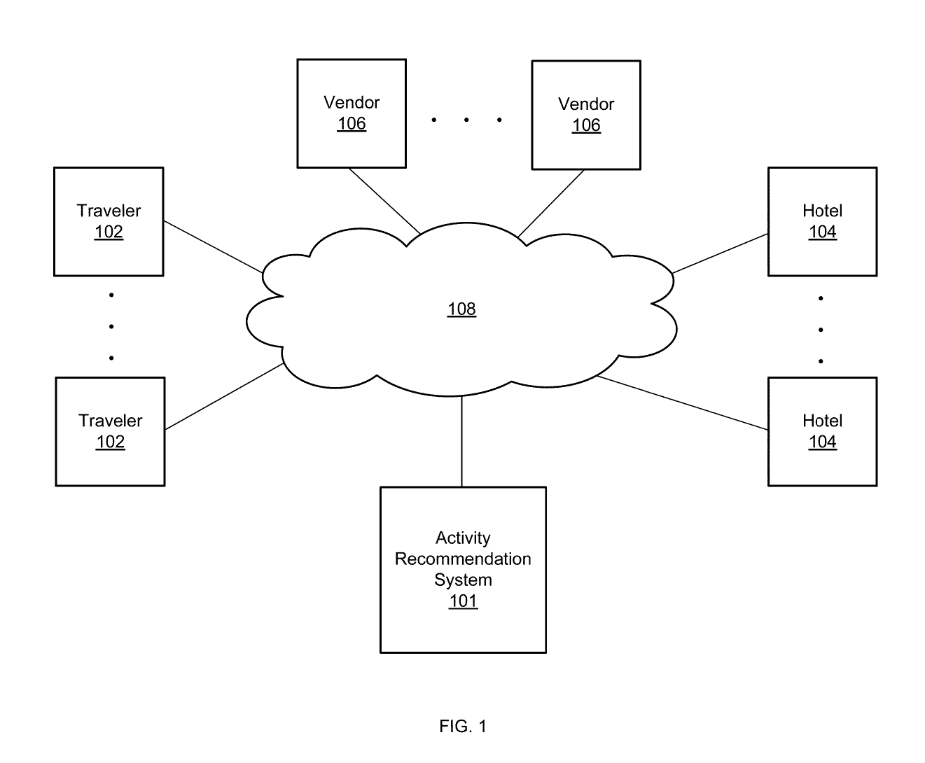

FIG. 1 illustrates an exemplary network, in which an activity recommendation system 100 in accordance with one or more embodiments may be implemented. The activity recommendation system 100 is preferably implemented in a computer server system, which communicates with a plurality of client devices operated by the users of the system 100, including travelers 102, hotels 104, and vendors 106. The client devices communicate with the activity recommendation system 100 over a communications network 108. The communications network 108 may comprise any network or combination of networks including, without limitation, the Internet, a local area network, a wide area network, a wireless network, and a cellular network.

The client devices operated by users to access the activity recommendation system 100 can comprise any computing device that can communicate with the computer server system including, without limitation, personal computers (including desktop, notebook, and tablet computers), smart phones, and cell phones.

Various embodiments disclosed herein are directed to providing targeted content to a traveler through a variety of messaging communications services including email, text message, social media message, or phone. Targeted content may refer to customized or personalized content which has been gathered, assembled, altered or filtered to particular specifications, such as a location parameter, time parameter, personal traveler preferences, or personal traveler settings. For example, a large number of pieces of content may be reduced to a small number of pieces of content based upon particular specifications, including a location parameter, time parameter, personal traveler preferences, or personal traveler settings. Targeted content may also be filtered on the basis of travel history and the like. Targeted content is preferably not delivered in conjunction with or at the same time as a travel confirmation, but is delivered after the travel confirmation such as a confirmation email from a hotel.

One embodiment of the method and system for providing targeted content to the traveler is with a customized email sent by the system to the traveler. Travelers often struggle to identify and reserve activities that are in line with their interests, location, and time parameters prior to and during their stay with a hotel whether on personal or business travel. The internet is cluttered today with activity vendors with most having websites and becoming more effective at online advertising and search engine optimization. Simple advertisements from vendors of activities are not sufficient and travelers often find themselves searching for long periods of time to find the right activities to do and are often disappointed.

As a result of having limited control over, influence on, and knowledge of what travelers are doing outside of the hotel, the hotel cannot customize the traveler's experience in the best way possible.

The targeted and customized content computer based delivery system described herein enables hotels to customize messages and recommend activities to travelers based on a set of parameters such as time period, location, preferences, and the like, as well as deliver that content to the traveler directly through a messaging system such as an email network. Such a messaging system could be owned by the hotel or provided as a service by a third-party provider, which sends out e-mail and other messages on behalf of the hotel.

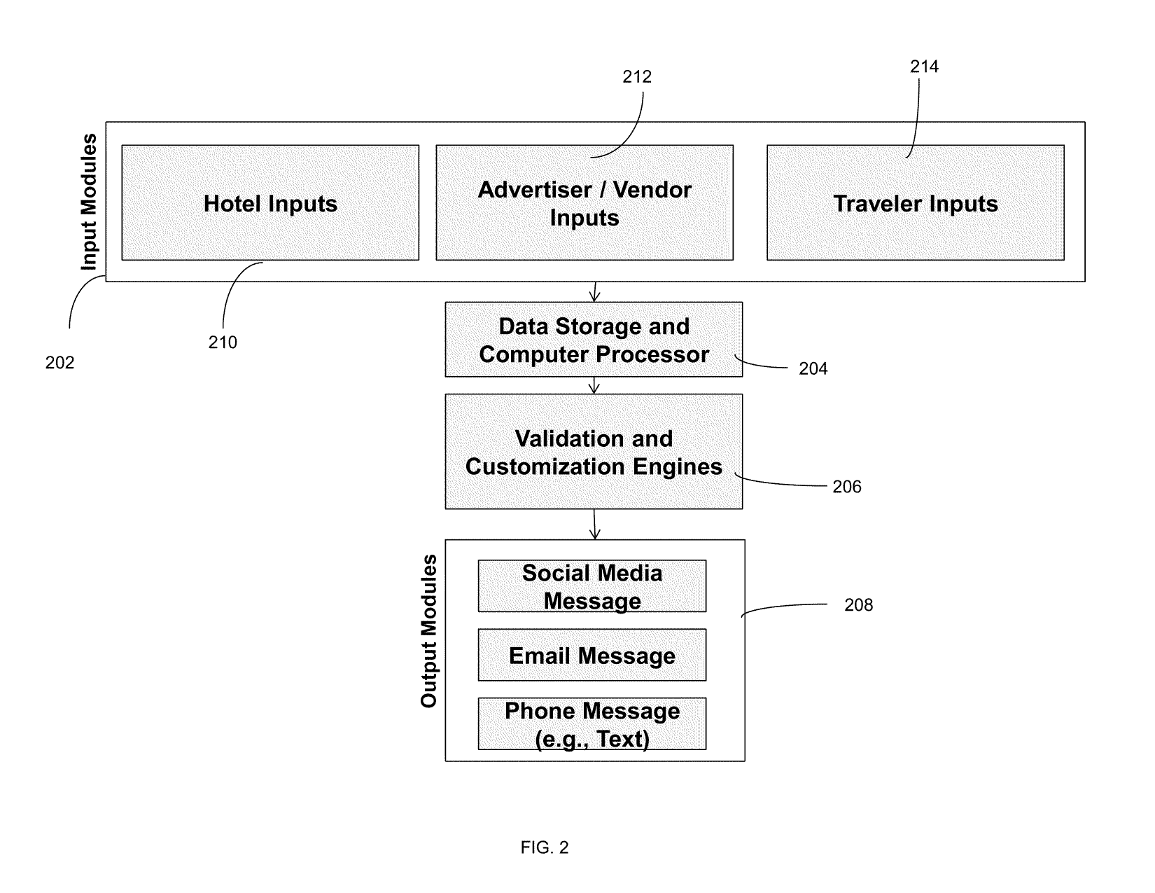

FIG. 2 illustrates an exemplary activity recommendation system 100 in accordance with one or more embodiments. The computer based system 100 includes an input module having multiple inputs 202, a data storage unit and a data processing unit 204, a validation and customization engine 206, and an output module 208. The input module 202 includes multiple input ports. For example, the input module 202 may include a first input port 210 for receiving inputs from the hotel, a second input port 212 for receiving inputs from the advertiser/vendor, and a third input port 214 for receiving inputs from the traveler.

Some of the hotel inputs received at the first input port 210 may include:
The number of times to reach out to each traveler prior to and during their stay;
The preferred method to reach out to the traveler (e.g., by text messaging, email, or social media messaging);
The timing that the hotel would like the system to reach out to each traveler (e.g., one week before the stay);
The number of activities that the hotel wants to recommend to the traveler;
An ability to customize the look and feel of each method of traveler contact (e.g., email);
A deposit or ‘bank’ of activities that are recommended and their ratings input by the place of lodging AND generated by the system;
Tracking statistics and reports of how travelers are interacting with the content and what they have decided to reserve;
Automated alerts when a traveler books something or when the system learns other information about the traveler through the system; and
The ability to input a activity vendors contact information, activity description, and the like so that the system can ‘invite’ the activity vendor to the system.

Some of the advertiser or vendor inputs received at the second input port 212 may include:
Demographics information for travelers that the advertiser wants to reach;
Other campaign information (e.g., budget, timing, etc.);
Descriptions of their activities and how the advertiser would like them to show up to the traveler;
Photographs and pictures of the activities and how the advertiser would like them to show up to the traveler;
Promotions or offers that the advertiser wants to show to the traveler and amount of time that the advertiser wants these to run for; and
Tracking statistics and reports of how travelers are interacting with the advertisements and content and what they have decided to reserve.

Some of the traveler inputs received at the third input port 214 may include:
Create new account, update account preferences, and login/logoff;
Update travel plans (date, location, etc.) through the website directly or other web-based applications;
Update activity preferences and the like;
Update past activities;
Update activities that have already been planned during the stay;
Update travel budgets;
Search for deals, promotions, or offers in a specified area that the traveler may be visiting;
Reserve deals, promotions, or offers in a specified area directly through the system's website;
Recommend deals, promotions, or offers to friends;
Sign up for real-time updates from the system during the traveler's stay; and
Responding to hotel recommendations before and/or after the activity is done in order for the system to better customized recommendations in the future.

The received inputs from the hotel, advertiser/vendors and the traveler are input and stored in a storage module 204. Once all of the inputs have been stored 204, the customization and validation engine 206 uses an algorithm to optimize and match the content with all inputs to create a customized message to deliver to the traveler. Additionally, the validation engine will make sure that all information associated with that activity provider or outside vendor is correct and that the vendor appropriately matches the quality of the other recommendations or inputs by leveraging proprietary methodology and publically available information. By validating the activity provider or vendor for the hotel, the system generally ensures that only the best and most appropriate recommendations are provided to the traveler. An output module 208 formats the custom message and outputs the message to the traveler and/or the hotel. The message 208 can be in any format designated by the hotel input 202 and can include, but is not limited to email, social media message, phone, text or the like. The message can be sent by the system's platform that could mimic being sent by the hotel, or the system could send the message through its own platform to appear as a third party, or the message could be sent directly by the hotel itself through one of its proprietary or third party systems (e.g., email system).

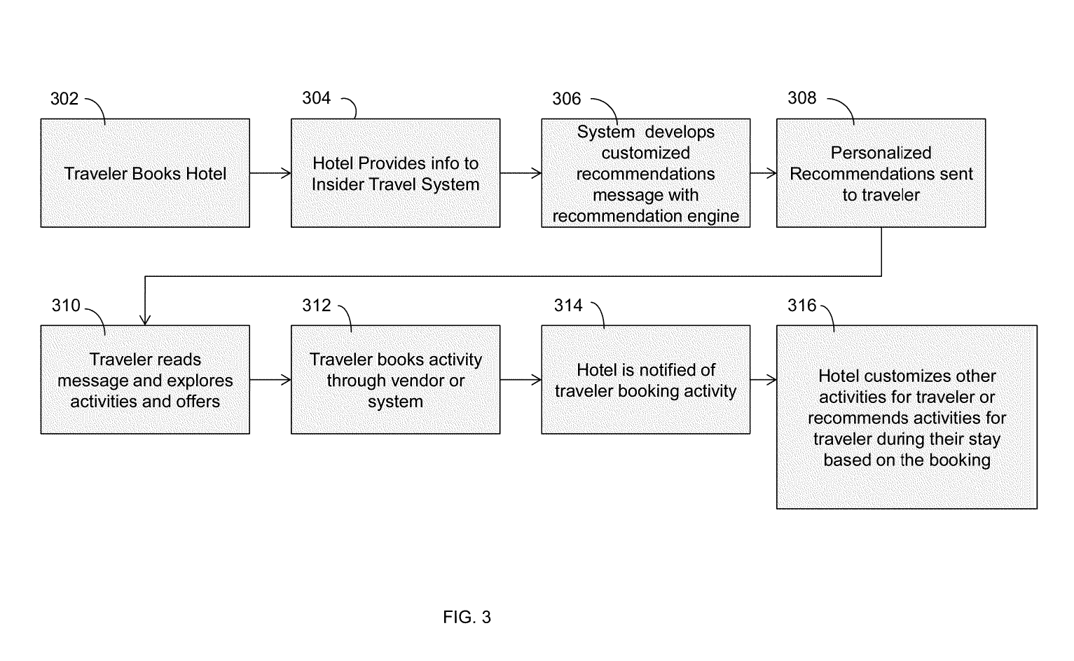

FIG. 3 illustrates an exemplary flow of how the computer based system interacts with the hotel and the traveler to enable the hotel to provide customized recommendations to the traveler and further customize the travel experience at the hotel for that traveler during their stay based on activities that the traveler reserved. After the traveler books their hotel 302, the hotel's information system will pass along the traveler information to the activity recommendation system 304. The customization engine will then create customized recommendations based on the traveler's preferences, hotel inputs, and activity vendor inputs 306. The system will then send the message to the traveler through the method specified by the hotel such as email, text message, social media message or the like 308. The traveler will then explore the recommended activities and offers by clicking on the links embedded in the message sent by the hotel 310 and may reserve the activities either on the activity vendor's website or through the system 312. Finally, the hotel is notified that traveler booked an activity that was recommended 314 and is able to further customize the traveler's experience by providing them in-hotel activities or offers that are more likely to be purchased or reserved because of the recommended activity that the traveler booked 316.

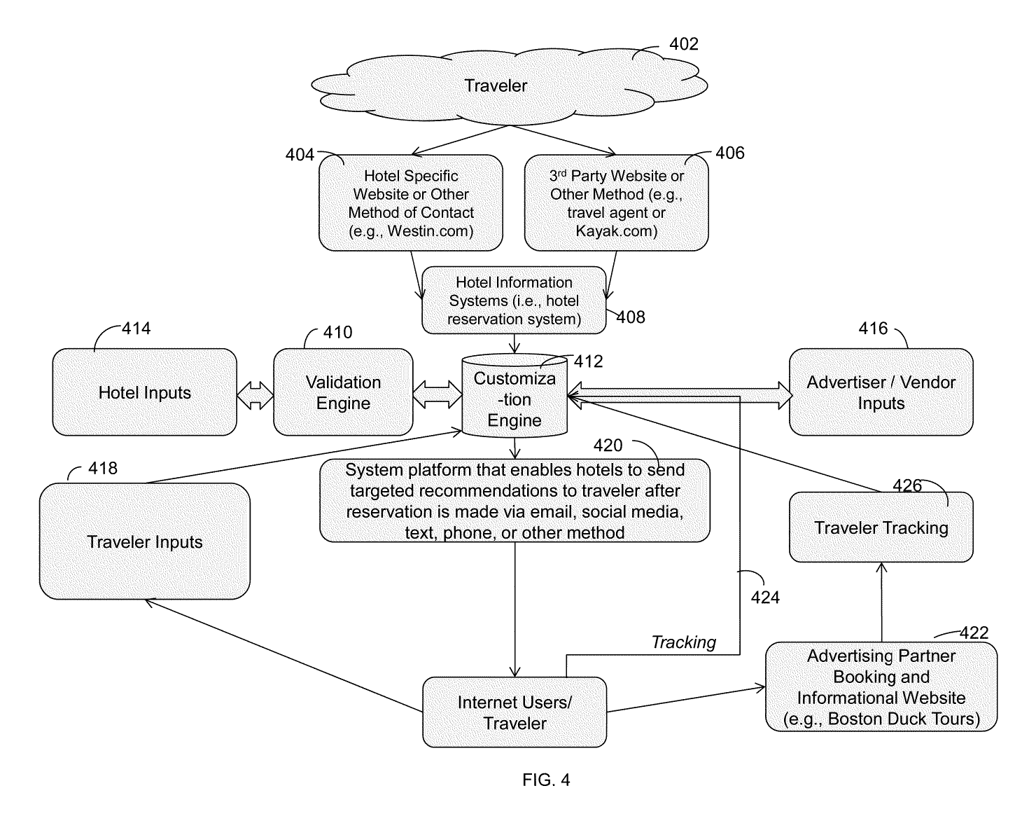

FIG. 4 illustrates a computer based method for delivering targeted content delivery through email, text message, social media message, or phone, based on recommendations for local activities from the travelers' hotel. A traveler 402 may reserve a stay directly from a hotel's website or booking agency or may also reserve a stay through a third party such as a travel agent, hotel aggregator website, or the like 404, 406. The reservation information is then sent to the hotel's information system and is further updated within the computer system's storage database 408. This could be done manually or in an automated way. Data associated with the hotel reservation may include name or identity information, gender information, time information and location information, travel preferences, and the like. Once the traveler reservation and other data is stored in the database, the validation engine 410 will ensure that the inputs and recommendations from the hotel are accurate and appropriate for distribution to the traveler by using proprietary data as well as publically available data. The customization engine 412 will then match up the settings input by the hotel 414, the settings input by the local activity vendor or advertiser 416, and the preferences input by the individual traveler 418 to come up with a customized set of recommended activities for that traveler's specific stay. If the activities that the hotel wants to recommend are not included in the current list of activity providers in the hotel preference settings, then the hotel can input the activity vendor's contact information, description, and the like and the system will automatically contact the activity vendor and ‘invite’ them to join the system and follow up through email, phone, and other methods of contact. The customized recommendation communications with travelers mainly driven by the settings input by the hotel because they are the party that is recommending trusted activities to do, but the other parties are also required for the computer based system to function properly.

Once all of the settings have been reconciled with the customization engine's algorithm and the system has come up with a customized message to deliver to the traveler, the message can be sent by the system's platform that could mimic being sent by the hotel, or the system could send the message through its platform to appear as a third party, or the message could be sent directly by the hotel itself through one of its systems 420. The method of delivery would be determined in the inputs 210 referring to FIG. 2 as described above. The recipients of the communication can then explore the activity vendor's website and reserve the activities either directly on their website 422 or on the traveler-facing portion of the system. The system will then track what activities or offers are explored and booked by the traveler 424, 426 and store this information in the database and customization engine 412 and report this information to the both the hotel and the activity vendor.

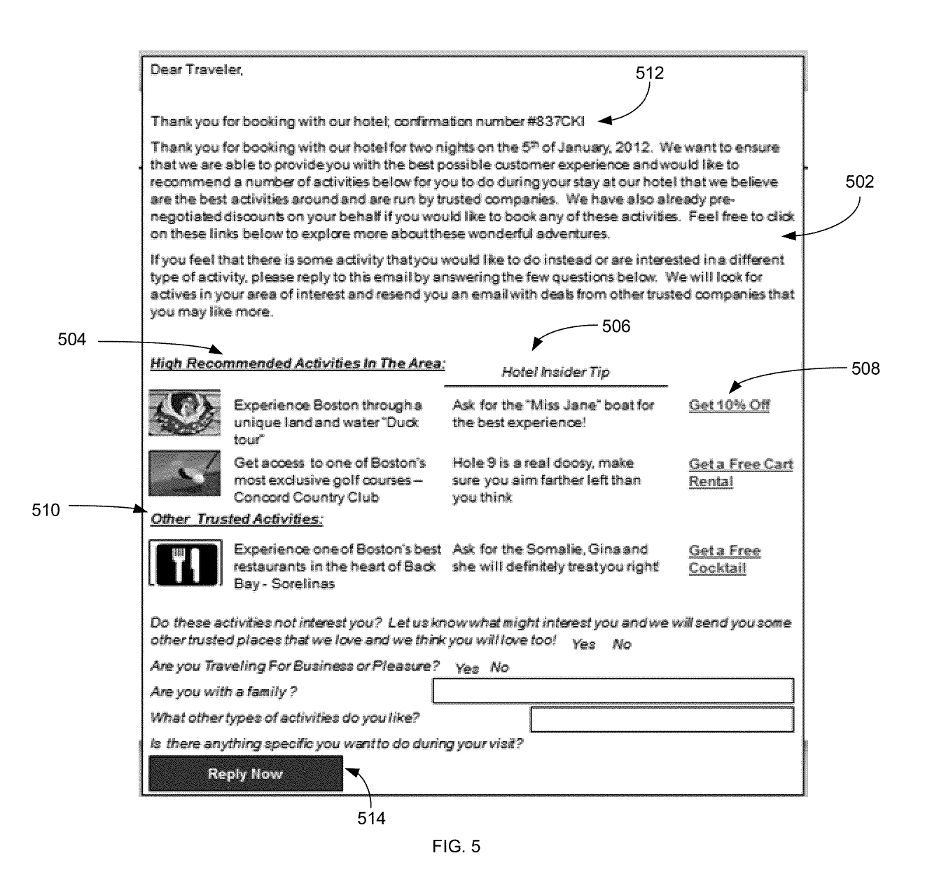

One way for a hotel to deliver a customized message with recommendations to a traveler is in email form. One example of a customized email message to the traveler is shown in FIG. 5. The exemplary email message includes the following sections or features:
Introduction and explanatory text 502
Customized local activities recommended by the hotel 504
‘Insider Tips’ given by the place of lodging to heighten the traveler's experience 506
Promotions, offers, or deals that the traveler can link to or book directly 508
Other activities that may not be highly recommended but may be of interest to the traveler 510
Confirmation, reservation, or similar number to prove identity or trustworthiness 512
Reply-based questions to potentially improve the targeting or recommend new activities 514

The hotel may also choose to send out emails that include only ‘insider tips’ that provide information to traveler about activities near their destination or their destination itself that only an area native may typically know. One example of this would be a ski area hotel sending an email to an upcoming travel that provides tips on which ski trail will have the best wind-blown powder or at what time specific ski lifts may open. These messages could also be sent in any form to the traveler (e.g., email, text message, social media message, and the like) and at any time after the reservation confirmation, including in real time during the traveler's stay. Real time messages to the traveler during the traveler's stay could also include promotions, offers, or deals based on the traveler or partner hotel preferences.

The processes of the activity recommendation system described above may be implemented in software, hardware, firmware, or any combination thereof. The processes are preferably implemented in one or more computer programs executing on a programmable computer (which can be part of the server computer system) including a processor, a storage medium readable by the processor (including, e.g., volatile and non-volatile memory and/or storage elements), and input and output devices. Each computer program can be a set of instructions (program code) in a code module resident in the random access memory of the computer. Until required by the computer, the set of instructions may be stored in another computer memory (e.g., in a hard disk drive, or in a removable memory such as an optical disk, external hard drive, memory card, or flash drive) or stored on another computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional components or joined together to form fewer components for performing the same functions. For example, the computer server system may comprise one or more physical machines, or virtual machines running on one or more physical machines. In addition, the computer server system may comprise a cluster of computers or numerous distributed computers that are connected by the Internet or another network.

Accordingly, the foregoing description and attached drawings are by way of example only, and are not intended to be limiting.

What is claimed is:

1. A computer-implemented method of providing customized product or service recommendations to a traveler in connection with a stay at a room provided by a lodging service, the method comprising the steps each performed by a computer system of:
(a) receiving data on products or services available from one or more vendors suitable for travelers staying at a room provided by the lodging service, data on the traveler, and data from personnel associated with the lodging service on preferred products or services;
(b) based on the data received at (a), determining one or more recommended products or services for the traveler during the stay at the room provided by the lodging service; and
(c) providing information on the one or more recommended products or services for delivery to the traveler.

2. The method of claim 1, wherein the products or services comprise products served at a restaurant or a bar, tours, spa services, health club services, golf rounds, transportation services, outdoor adventure services, skiing services, theatrical entertainment, museums, aquariums, or zoos.

3. The method of claim 1, wherein the personnel associated with the lodging service comprise a concierge or desk clerk.

4. The method of claim 1, further comprising validating the preferred products or services based on an input from the personnel associated with the lodging service.

5. The method of claim 4, wherein validating the preferred products or services comprises confirming that the preferred products or services are suitable for recommendation and include accurate information.

6. The method of claim 1, wherein the information on recommended products or services is transmitted to the traveler by e-mail, text messaging, or social media messaging.

7. The method of claim 1, wherein the information on recommended products or services is transmitted to the traveler using existing hotel services for communicating with travelers.

8. The method of claim 1, wherein the information on recommended products or services is transmitted to the traveler in a pre-stay e-mail.

9. The method of claim 1, wherein the data on the traveler comprises a profile of the traveler including demographic information on the traveler, information on preferences of the traveler, or traveler settings.

10. The method of claim 1, further comprising providing one or more coupons associated with the one or more recommended products or services to the traveler.

11. The method of claim 1, further comprising receiving notification of a booking by the traveler for one or more given products or services from the one or more recommended products or services, and identifying one or more additional products or services to recommend to the traveler based on the booking.

12. The method of claim 1, wherein the received inputs are stored in a data storage system.

13. The method of claim 1, further comprising (d) transmitting an e-mail, text message, or social media message with the one or more product or service recommendations to the traveler.

14. The method of claim 1, wherein the lodging service comprises a hotel, a resort, a motel, an inn, a bed & breakfast facility, or a web-based room reservation service.

15. A computer system, comprising:
at least one processor;
memory associated with the at least one processor; and
a program supported in the memory for providing customized product or service recommendations to a traveler in connection with a stay at a room provided by a lodging service, the program having a plurality of instructions stored therein which, when executed by the at least one processor, cause the at least one processor to:
(a) receive data on products or services available from one or more vendors suitable for travelers staying at a room provided by the lodging service, data on the traveler, and data from personnel associated with the lodging service on preferred products or services;
(b) based on the data received at (a), determine one or more recommended products or services for the traveler during the stay at the room provided by the lodging service; and
(c) provide information on the one or more recommended products or services for delivery to the traveler.

16. The system of claim 15, wherein the products or services comprise products served at a restaurant or a bar, tours, spa services, health club services, golf rounds, transportation services, outdoor adventure services, skiing services, theatrical entertainment, museums, aquariums, or zoos.

17. The system of claim 15, wherein the personnel associated with the lodging service comprise a concierge or desk clerk.

18. The system of claim 15, further comprising validating the preferred products or services based on an input from the personnel associated with the lodging service.

19. The method of claim 18, wherein validating the preferred products or services comprises confirming that the preferred products or services are suitable for recommendation and include accurate information.

20. The system of claim 15, wherein the information on recommended products or services is transmitted to the traveler by e-mail, text messaging, or social media messaging.

21. The system of claim 15, wherein the information on recommended products or services is transmitted to the traveler using existing hotel services for communicating with travelers.

22. The system of claim 15, wherein the information on recommended products or services is transmitted to the traveler in a pre-stay e-mail.

23. The system of claim 15, wherein the data on the traveler comprises a profile of the traveler including demographic information on the traveler, information on preferences of the traveler, or traveler settings.

24. The system of claim 15, further comprising providing one or more coupons associated with the one or more recommended products or services to the traveler.

25. The system of claim 15, further comprising instructions causing the at least one processor to receive notification of a booking by the traveler for one or more given products or services from the one or more recommended products or services, and identify one or more additional products or services to recommend to the traveler based on the booking.

26. The system of claim 15, wherein the received inputs are stored in a data storage system.

27. The system of claim 15, further comprising instructions causing the at least one processor to transmit an e-mail, text message, or social media message with the one or more product or service recommendations to the traveler.

28. The system of claim 15, wherein the lodging service comprises a hotel, a resort, a motel, an inn, a bed & breakfast facility, or a web-based room reservation service.
